(19) United States
(12) Patent Application Publication
(10) Pub. No.: US 2011/0256463 A1
(43) Pub. Date: Oct. 20, 2011

(54) PARALLEL FUEL CELL STACK ARCHITECTURE

(75) Inventors: Steven C. Michalske, Sunnyvale, CA (US); Bradley L. Spare, San Jose, CA (US)

(73) Assignee: APPLE INC., Cupertino, CA (US)

(21) Appl. No.: 12/761,284

(22) Filed: Apr. 15, 2010

(51) Int. Cl. H01M 8/10; H01M 8/00; H01M 8/24

(52) U.S. Cl. 429/465; 429/452; 29/623.1; 429/471

(57) ABSTRACT

The disclosed embodiments relate to a system that provides a power source. The power source includes a set of fuel cells arranged in a fuel cell stack. The power source also includes a power bus configured to connect the fuel cells in a parallel configuration.

### BACKGROUND

1. Field

The present embodiments relate to power sources for electronic devices. More specifically, the present embodiments relate to a parallel fuel cell stack architecture with voltage-multiplying circuitry and fuel cells arranged in a monopolar stacked configuration.

2. Related Art

Fuel cells provide electrical power by converting a source fuel, such as hydrogen or a hydrocarbon, into an electric current and a waste product. In particular, a fuel cell contains an anode, a cathode, and an electrolyte between the anode and cathode. Electricity may be generated by two chemical reactions within the fuel cell. First, a catalyst at the anode oxidizes the fuel to produce positively charged ions and negatively charged electrons. The electrolyte may allow ions from the oxidation process to pass through to the cathode while blocking passage of the electrons. The electrons may thus be used to drive a load connected to the fuel cell before recombining with the ions and a negatively charged atom (e.g., oxygen) at the cathode to form a waste product such as carbon dioxide and/or water.

Because fuel cells are typically associated with low voltages (e.g., 0.5-0.7 volts), multiple fuel cells may be combined to form a fuel cell stack. For example, a fuel cell stack may contain a number of stacked bipolar plates. Each bipolar plate may provide an anode on one side and a cathode on the other side. To form fuel cells within the stack, the catalyst and the electrolyte may be placed in between the bipolar plates. The fuel cells may then be connected in series to increase the voltage of the fuel cell stack.

However, existing fuel cell stack architectures may have a number of disadvantages. First, each fuel cell may represent a single point of failure in a series-connected fuel cell stack. In addition, a fuel cell may be subject to a number of failure modes, including accumulation of nitrogen in the anode, poisoning of the catalyst, degradation of the electrolyte, and/or water flooding in the anode or cathode. Consequently, the reliability of a fuel cell stack may decrease as the number of fuel cells in the fuel cell stack increases.

Second, bipolar plates for fuel cell stacks are typically manufactured using materials that are both conductive and corrosion-resistant, such as stainless steel. However, the high density of such materials may result in heavy bipolar plates that restrict the use of fuel cell stacks in portable applications. For example, adoption of a fuel cell stack design as a power source for portable electronic devices may be hampered by the weight of the resulting fuel cell stack, the majority of which is in stainless-steel bipolar plates.

Hence, the use of fuel cells as power sources may be facilitated by improvements in the reliability, weight, and/or size of fuel cell stacks.

### SUMMARY

The disclosed embodiments relate to a system that provides a power source. The power source includes a set of fuel cells arranged in a fuel cell stack. The power source also includes a power bus configured to connect the fuel cells in a parallel configuration.

In some embodiments, the power source also includes a voltage-multiplying circuit configured to increase a voltage of the fuel cell stack.

In some embodiments, the voltage-multiplying circuit is connected to the power bus.

In some embodiments, the voltage-multiplying circuit increases the voltage of the fuel cell stack by a power of two.

In some embodiments, the fuel cells are arranged in a monopolar configuration that enables sharing of an electrode between two adjacent fuel cells in the fuel cell stack.

In some embodiments, each of the fuel cells corresponds to a proton exchange membrane (PEM) fuel cell.

### BRIEF DESCRIPTION OF THE FIGURES

FIG. 1 shows a schematic of a system in accordance with the disclosed embodiments.

FIG. 2 shows a set of fuel cells arranged in a monopolar configuration in accordance with the disclosed embodiments.

FIG. 3 shows a set of fuel cells in accordance with the disclosed embodiments.

FIG. 4 shows a power source in accordance with the disclosed embodiments.

FIG. 5 shows a flowchart illustrating the process of providing a power source in accordance with the disclosed embodiments.

FIG. 6 shows a portable electronic device in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments provide a fuel cell stack architecture with multiple fuel cells connected in a parallel configuration by a power bus. In addition, a voltage-multiplying circuit may be connected to the power bus to increase the voltage of the fuel cell stack. For example, the voltage-multiplying circuit may allow the fuel cell stack to power one or more components in a portable electronic device. The fuel cell stack architecture may thus increase the reliability of the fuel cell stack while allowing fuel cells in a parallel configuration to power components and/or devices with higher operating voltages than those normally produced by individual fuel cells.

The fuel cell stack architecture may additionally reduce the size, weight, and/or material cost of the fuel cell stack. More specifically, the fuel cells may be arranged in a monopolar configuration that enables sharing of electrodes between adjacent fuel cells in the fuel cell stack. Such sharing of electrodes may significantly reduce the number of electrodes in the fuel cell stack and/or enable the use of monopolar plates that are lighter and thinner than bipolar plates in the fuel cell stack. As a result, a monopolar fuel cell stack may be smaller and/or cheaper than a bipolar fuel cell stack with the same number of fuel cells or more powerful than a bipolar fuel cell stack of the same size.

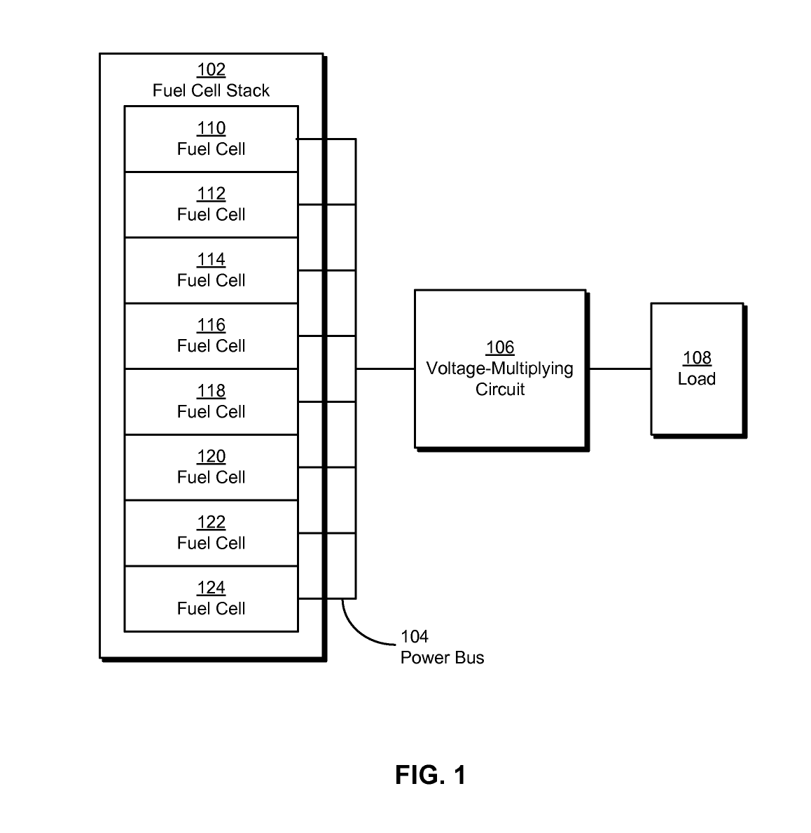

FIG. 1 shows a schematic of a system in accordance with the disclosed embodiments. The system may provide a power source to a portable electronic device, such as a mobile phone, laptop computer, portable media player, and/or peripheral device. As shown in FIG. 1, the system includes a number of fuel cells 110-124 arranged in a fuel cell stack 102, a power bus 104, and a voltage-multiplying circuit 106. Each of these components is discussed in further detail below.

Fuel cells 110-124 may correspond to electrochemical cells that convert a source fuel into electric current and a waste product. In particular, fuel cells 110-124 may be proton exchange membrane (PEM) fuel cells that use hydrogen as a fuel. The hydrogen may be catalytically split into protons and electrons at the anode of each PEM fuel cell. The protons may pass through an electrically insulating membrane electrode assembly (MEA) to the cathode of the PEM fuel cell, while the electrons may travel through a load 108 to the cathode. The protons and electrons may then react with oxygen atoms at the cathode to form water molecules as a waste product. Alternatively, fuel cells 110-124 may correspond to solid oxide fuel cells, molten carbonate fuel cells, direct methanol fuel cells, alkaline fuel cells, and/or other types of fuel cells.

Because individual fuel cells 110-124 may generate a voltage (e.g., 0.5-0.7 volts for PEM fuel cells) that is too low to drive most components (e.g., processors, peripheral devices, backlights, displays, Universal Serial Bus (USB) ports, etc.) in load 108, fuel cells 110-124 may be electrically connected in a series configuration. For example, a set of 25 PEM fuel cells may be connected in series within fuel cell stack 102 to increase the voltage of fuel cell stack 102 to roughly 12.5-17.5 volts. The increased voltage may then be used to drive components with operating voltages at or below the voltage of fuel cell stack 102.

Furthermore, fuel cells 110-124 may be assembled into fuel cell stack 102 to conserve space and/or provide a packaged power source for driving load 108. To form fuel cells 110-124 within fuel cell stack 102, layers of MEA may be sandwiched between a set of stacked bipolar plates. Each bipolar plate may include a corrugated side that functions as a cathode for one fuel cell and a smooth side that functions as an anode for an adjacent fuel cell. In addition, the bipolar plate may be made from a conductive, corrosion-resistant material such as stainless steel to enable the electrodes to conduct electric current while resisting corrosion from water vapor at the cathode.

However, the series connection of fuel cells 110-124 may create a single point of failure for each fuel cell in fuel cell stack 102. Moreover, each fuel cell 110-124 may be subject to a number of failure modes, such as accumulation of nitrogen in the anode, poisoning of the catalyst, degradation of the electrolyte, and/or water flooding in the anode or cathode. As a result, fuel cell stack 102 may be less reliable than other power sources, particularly as the number of fuel cells in fuel cell stack 102 increases. For example, a fuel cell stack containing 400 fuel cells for powering a car may have a much higher failure rate than a fuel cell stack containing 25 fuel cells for powering a laptop computer, while both fuel cell stacks may have higher failure rates than a 12-volt battery containing six series-connected galvanic cells.

At the same time, the creation of fuel cells 110-124 from bipolar plates made of high-density materials such as stainless steel may increase the size, weight, and/or cost of fuel cell stack 102. For example, stainless-steel bipolar plates may be responsible for 80% of the weight and 30% of the cost of fuel cell stack 102. Along the same lines, corrugation on the cathode side of a bipolar plate may form channels in the center of the bipolar plate that increase the size and/or volume of fuel cell stack 102 without providing functionality to fuel cell stack 102.

In one or more embodiments, the system of FIG. 1 mitigates issues associated with fuel cell stack architectures that contain series-connected fuel cells and/or bipolar plates. First, fuel cells 110-124 may be connected in a parallel configuration by power bus 104. Within the parallel configuration, each fuel cell may operate as a redundant component for another fuel cell in fuel cell stack 102. In other words, the parallel connection of fuel cells 110-124 may allow fuel cell stack 102 to continue supplying power after multiple fuel cell failures instead of failing as a whole after a single fuel cell failure. Consequently, the parallel configuration of fuel cells 110-124 may represent a significant improvement in reliability over a series configuration of fuel cells 110-124.

In addition, the low voltage of parallel-connected fuel cells 110-124 may be remedied by connecting voltage-multiplying circuit 106 to power bus 104. For example, the voltage of fuel cell stack 102 may be doubled by coupling a high-efficiency voltage-doubling circuit to power bus 104. The voltage-doubling circuit may include capacitors and inductors for energy storage, as well as a set of metal-oxide-semiconductor field-effect transistors (MOSFETs) that function as switches with very low resistance and low inductance path when on and extremely high resistance path when off. The output of the voltage-doubling circuit may then be fed into the input of a second voltage-doubling circuit to quadruple the voltage. Additional voltage-doubling circuits may be added in the same fashion to increase the voltage supplied to load 108 by larger powers of two while maintaining negligible conduction loss.

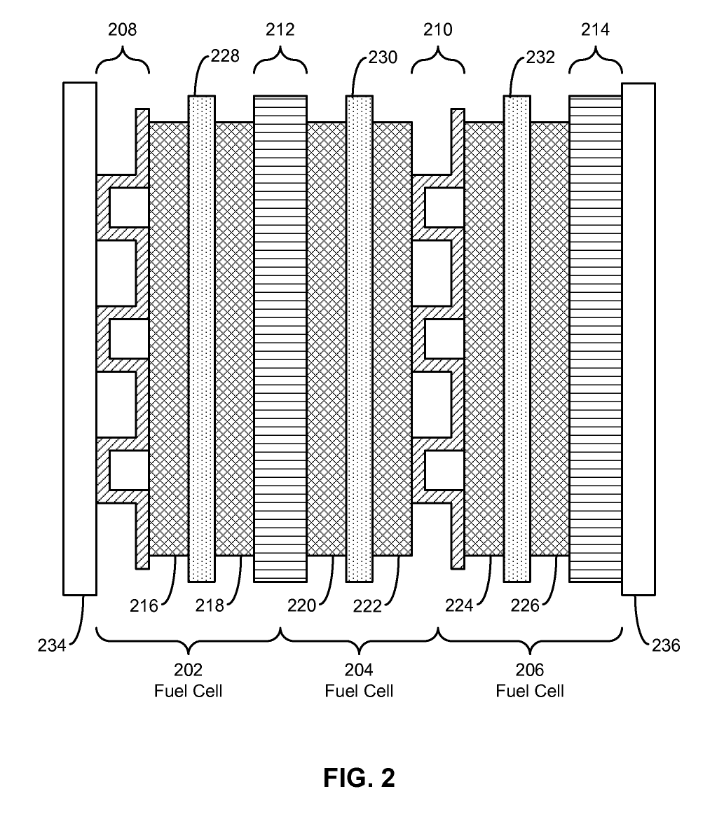

Second, fuel cells 110-124 may be arranged in a monopolar configuration that utilizes monopolar plates that are thinner, lighter, and more compact than bipolar plates. Moreover, the monopolar plates may be stacked in an alternating pattern within fuel cell stack 102 to facilitate sharing of electrodes between adjacent fuel cells. As discussed below with respect to FIG. 2, the use and sharing of monopolar plates may reduce the amount of electrode material in fuel cell stack 102 by roughly 50%.

Those skilled in the art will appreciate that the alternating pattern of anodes and cathodes in the monopolar configuration may produce adjacent pairs of fuel cells with polarities that mirror one another. For example, two adjacent fuel cells may be formed around a single anode by placing an MEA followed by a cathode on either side of the anode. One fuel cell may thus be oriented with the cathode to the left of the anode, while the other fuel cell may be oriented with the cathode to the right of the anode. Such mirroring of polarities may further preclude the use of the monopolar configuration in a series-connected set of fuel cells. Consequently, the reduced size, weight, and/or cost in a fuel cell stack with a monopolar configuration may only be realized by connecting the fuel cells in a parallel configuration.

FIG. 2 shows a set of fuel cells 202-206 arranged in a monopolar configuration in accordance with the disclosed embodiments. As shown in FIG. 2, fuel cells 202-206 are sandwiched between a cathode endplate 234 and an anode endplate 236. In addition, fuel cells 202-206 are formed from four monopolar plates corresponding to two cathodes 208-210 and two anodes 212-214. To enable the creation of three fuel cells 202-206 from four electrodes, cathodes 208-210 and anodes 212-214 are alternated between endplates 234-236. In particular, cathode 208, anode 212, cathode 210, and anode 214 are arranged from left to right between endplates 234-236, with cathode 208 adjacent to endplate 234 and anode 214 adjacent to endplate 236.

Fuel cells also include a set of MEAs 228-232 and a set of gas-diffusion layers (GDLs) 216-226. MEAs 228-232 may be composed of Nafion (Nafion™ is a registered trademark of E. I. du Pont de Nemours and Company), while GDLs 216-226 may correspond to graphite, carbon cloth, and/or carbon fiber layers that flank MEAs 228-232. Furthermore, MEAs 228-232 and GDLs 216-226 are sandwiched between cathodes 208-210 and anodes 212-214. In particular, MEA 228 and GDLs 216-218 are sandwiched between cathode 208 and anode 212, MEA 230 and GDLs 220-222 are sandwiched between anode 212 and cathode 210, and MEA 232 and GDLs 224-226 are sandwiched between cathode 210 and anode 214.

Each fuel cell 202-206 may thus correspond to a PEM fuel cell that includes a cathode, an anode, an MEA, and two GDLs. To produce electricity, hydrogen gas may be supplied from the anode side, while oxygen may be supplied from the cathode side. The hydrogen may permeate the GDL adjacent to the anode and split into protons and electrons after coming into contact with a catalyst (e.g., platinum) coating the anode side of the MEA. Similarly, the oxygen may permeate the GDL adjacent to the cathode and split into two oxygen atoms after coming into contact with a catalyst coating the cathode side of the MEA. The oxygen atoms may contain a negative charge that attracts the protons, which travel through the MEA to reach the GDL adjacent to the cathode.

On the other hand, the MEA may block the passage of electrons, requiring the electrons to travel through an external circuit to reach the cathode side of the MEA. Such diverting of the electrons through the external circuit may allow the fuel cell to supply electrical power to a load. After reaching the cathode side of the MEA through the external circuit, the electrons may combine with the oxygen and hydrogen to form water as a waste product. The water may then evaporate and/or drain out of channels formed by the corrugation of the cathode.

As mentioned above, the monopolar configuration may utilize only monopolar plates in forming fuel cells 202-206. Each monopolar plate may thus correspond to one side of a bipolar plate, and each cathode-anode pair for a fuel cell 202-206 may contribute the same volume, weight, and/or cost as a bipolar plate with a cathode side and an anode side. Furthermore, the sharing of electrodes by fuel cells 202-206 may represent a reduction in volume, weight, and/or cost over fuel cells formed using bipolar plates. For example, fuel cells 202-206 may use one fewer cathode and one fewer anode than three fuel cells created from bipolar plates, resulting in a space, weight, and/or cost savings of one bipolar plate.

In general, the number of electrodes in a fuel cell stack with a monopolar configuration may approach half the number of electrodes in a fuel cell stack with a bipolar configuration as the number of fuel cells increases. In a bipolar configuration, the number of electrodes (e.g., anodes and electrodes) may be double the number of MEAs (e.g., fuel cells) in the fuel cell stack, while in the monopolar configuration, the number of electrodes may be one more than the number of MEAs. Consequently, electrodes in a fuel cell stack with a monopolar configuration may take up roughly half the amount of space and/or weight of electrodes in a fuel cell stack with a bipolar configuration.

As discussed above, the monopolar configuration of FIG. 2 may also be used in conjunction with a parallel configuration for electrically connecting fuel cells 202-206. To connect fuel cells 202-206 in parallel, cathode 210 may be coupled to endplate 234 to form a positive terminal, and anode 212 may be coupled to endplate 236 to form a negative terminal. The parallel configuration may allow fuel cells 202-206 to continue driving a load after the failure of one or even two fuel cells. For example, cathode 210 and anodes 212-214 may continue driving the load if fuel cell 202 fails. Likewise, fuel cell 206 may continue producing electricity after a failure in anode 212 disrupts the operation of fuel cells 202-204.

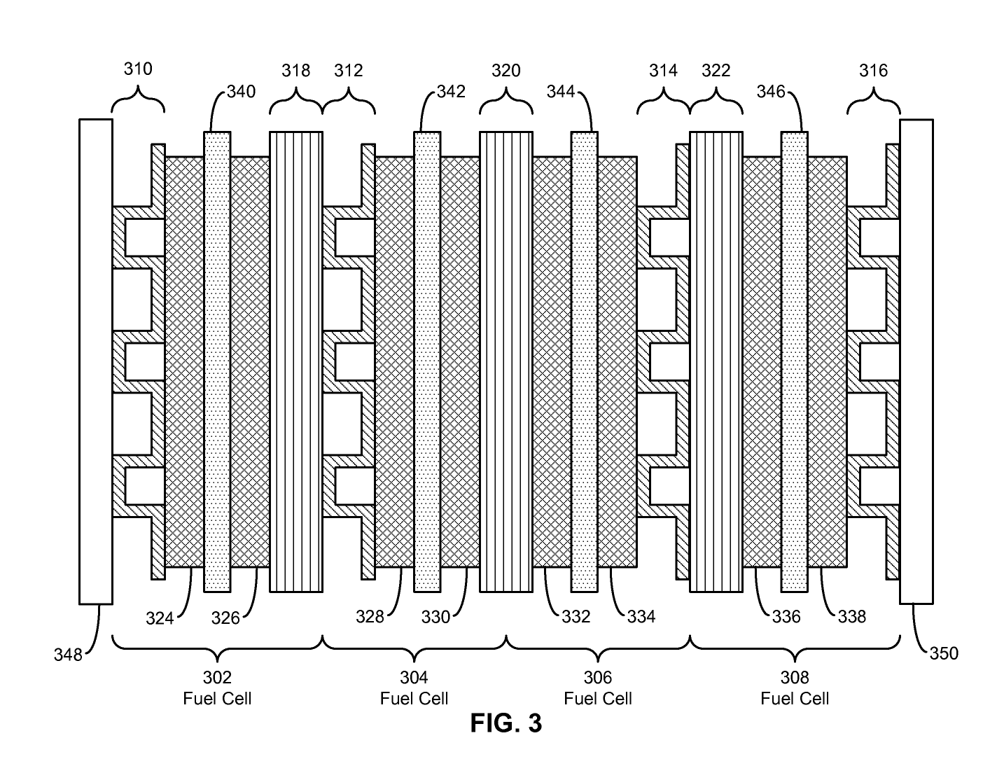

FIG. 3 shows a set of fuel cells 302-308 in accordance with the disclosed embodiments. Fuel cells 302-308 are sandwiched between two cathode endplates 348-350 and are formed from four cathodes 310-316 and three anodes 318-322. As shown in FIG. 3, fuel cell 302 includes cathode 310 and anode 318, fuel cell 304 includes cathode 312 and anode 320, fuel cell 308 includes anode 320 and cathode 314, and fuel cell 308 includes anode 322 and cathode 316. As with fuel cells 202-206 of FIG. 2, an MEA 340-346 and two GDLs 324-338 are sandwiched between the cathode and anode of each fuel cell 302-308 to facilitate the generation of electricity using the fuel cell.

In one or more embodiments, fuel cells 302-308 are created from three monopolar plates and two bipolar plates. In particular, monopolar plates may be used for cathodes 310 and 316 and anode 320, while anode 318 and cathode 312 may form a first bipolar plate and cathode 314 and anode 322 may form a second bipolar plate. The combined use of monopolar and bipolar plates may further enable the connection of fuel cells 302-308 in a series-and-parallel configuration. More specifically, the use of bipolar plates to supply cathodes 312-314 and anodes 318 and 322 may result in the series connections of fuel cells 302-304 and fuel cells 306-308, while the sharing of anode 320 between fuel cells 304-306 may allow for the parallel connection of fuel cells 304-306.

Consequently, fuel cells 302-308 may be connected in a two in series, two in parallel (2s2p) configuration by coupling endplates 348-350 to form a positive terminal and using anode 320 as a negative terminal. In the 2s2p configuration, fuel cells 302-308 may provide a savings of one monopolar plate (e.g., cathode) and double the redundancy over four fuel cells connected in a series configuration using bipolar plates. At the same time, the 2s2p configuration of fuel cells 302-308 may provide twice the voltage of four fuel cells connected in a parallel configuration. In other words, fuel cells 302-308 may have more redundancy than the same number of fuel cells connected in a series configuration while producing more voltage than the same number of fuel cells connected in a parallel configuration.

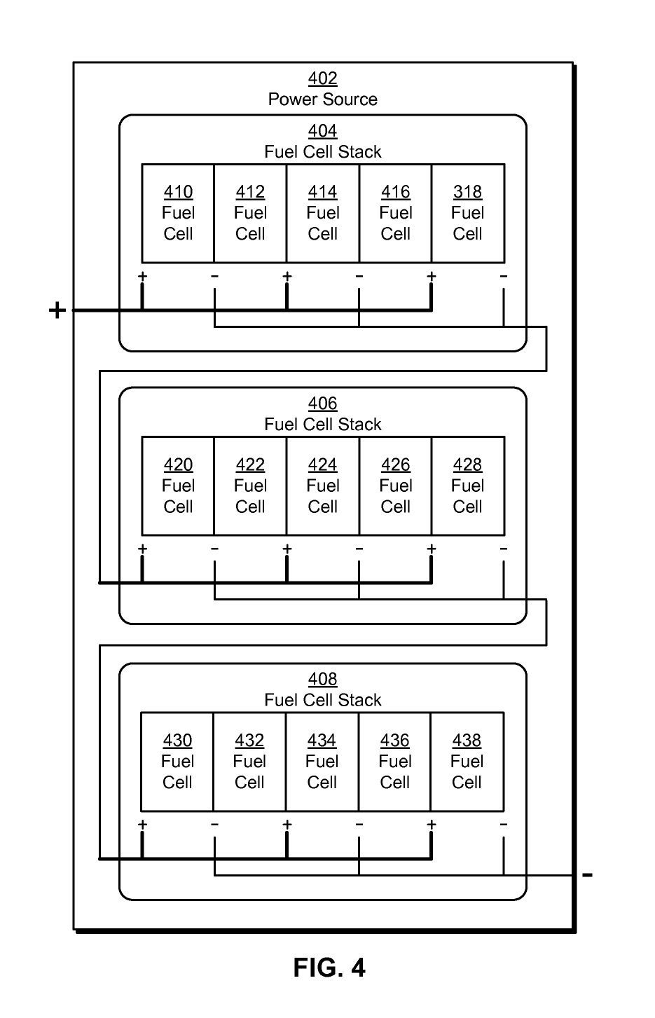

FIG. 4 shows a power source 402 in accordance with the disclosed embodiments. Power source 402 contains a set of fuel cells 410-438 assembled into three fuel cell stacks 404-408. Furthermore, fuel cells in each fuel cell stack are connected in a parallel configuration, while fuel cell stacks 404-408 are connected in series.

As with fuel cells 302-308 of FIG. 3, fuel cells 410-438 in power source 402 may provide increased redundancy over the same number of fuel cells connected in a series configuration and produce more voltage than the same number of fuel cells connected in a parallel configuration. In particular, each parallel-connected fuel cell may provide redundancy for a fuel cell stack, while the series connection of fuel cell stacks 404-408 may produce an additive effect on the voltage of power source 402. Power source 402 may thus provide five times the redundancy of 15 series-connected fuel cells and three times the voltage of 15 parallel-connected fuel cells.

The serial connection of fuel cell stacks 404-408 containing parallel-connected fuel cells may also represent a space, weight, and/or cost savings over the parallel connection of fuel cell stacks containing series-connected fuel cells. As discussed above, one or more fuel cell stacks 404-408 may contain fuel cells arranged in a monopolar configuration to save space, weight, and/or material costs over fuel cell stacks with bipolar configurations. However, series-connected fuel cells may not be able to utilize the monopolar configuration. As a result, parallel-connected fuel cell stacks with series configurations may require the use of bipolar plates, which may be heavier, bulkier, and costlier than the monopolar plates used in monopolar configurations of fuel cell stacks 404-408.

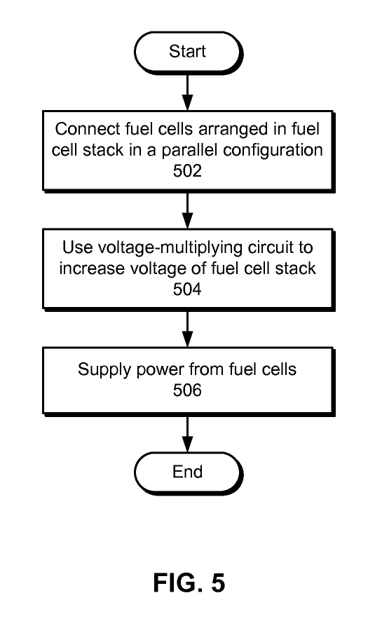

FIG. 5 shows a flowchart illustrating the process of providing a power source in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, fuel cells arranged in a fuel cell stack are connected in a parallel configuration (operation 502). The fuel cells may correspond to PEM fuel cells, solid oxide fuel cells, molten carbonate fuel cells, direct methanol fuel cells, alkaline fuel cells, and/or other types of fuel cells. The fuel cells may be arranged in a monopolar configuration that enables sharing of an electrode between every two adjacent fuel cells in the fuel cell stack. As a result, the fuel cell stack may be lighter, smaller, and/or cheaper than a fuel cell stack in a bipolar configuration.

Next, a voltage-multiplying circuit is used to increase the voltage of the fuel cell stack (operation 504). The voltage-multiplying circuit may include one or more high-efficiency voltage-doubling circuits that increase the voltage of the fuel cell stack by a power of two. The use of the voltage-multiplying circuit with the parallel configuration of the fuel cells may allow the fuel cell stack to operate as a power source with ample amounts of both redundancy and voltage. Finally, power is supplied from the fuel cells (operation 506). For example, the fuel cell stack may be used in lieu of a battery pack in driving a load.

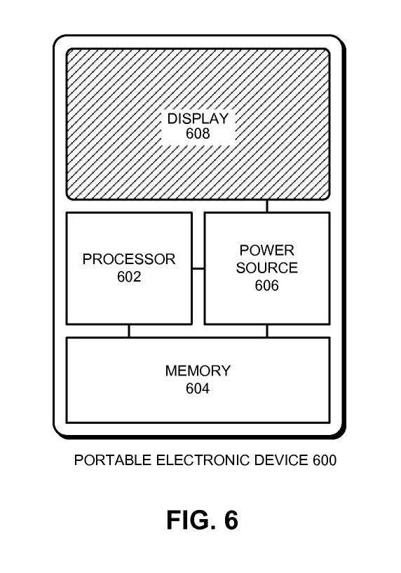

The above-described fuel cell stack can generally be used in any type of electronic device. For example, FIG. 6 illustrates a portable electronic device 600 which includes a processor 602, a memory 604 and a display 608, which are all powered by a power source 606. Portable electronic device 600 may correspond to a laptop computer, mobile phone, personal digital assistant (PDA), portable media player, digital camera, and/or other type of compact electronic device. Power source 606 may correspond to a fuel cell stack that includes a set of fuel cells connected in a parallel configuration and/or arranged in a monopolar configuration. In addition, power source 606 may include a voltage-multiplying circuit that increases a voltage of the fuel cell stack to at least an operating voltage of one or more of the components (e.g., processor 602, memory 604, display 608, USB port, peripheral device, etc.) in portable electronic device 600.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A power source, comprising:
a set of fuel cells arranged in a fuel cell stack; and
a power bus configured to connect the fuel cells in a parallel configuration.

2. The power source of claim 1, further comprising:
a voltage-multiplying circuit configured to increase a voltage of the fuel cell stack.

3. The power source of claim 2, wherein the voltage-multiplying circuit is connected to the power bus.

4. The power source of claim 2, wherein the voltage-multiplying circuit increases the voltage of the fuel cell stack by a power of two.

5. The power source of claim 1, wherein the fuel cells are arranged in a monopolar configuration that enables sharing of an electrode between two adjacent fuel cells in the fuel cell stack.

6. The power source of claim 1, wherein each of the fuel cells corresponds to a proton exchange membrane (PEM) fuel cell.

7. A method for providing a power source, comprising:
connecting fuel cells arranged in a fuel cell stack in a parallel configuration; and
supplying power from the fuel cells.

8. The method of claim 7, wherein the fuel cells are connected in the parallel configuration by a power bus.

9. The method of claim 8, further comprising:
using a voltage-multiplying circuit to increase a voltage of the fuel cell stack.

10. The method of claim 9, wherein the voltage-multiplying circuit is connected to the power bus.

11. The method of claim 7, wherein the fuel cells are arranged in a monopolar configuration that enables sharing of an electrode between two adjacent fuel cells in the fuel cell stack.

12. The method of claim 7, wherein each of the fuel cells corresponds to a proton exchange membrane (PEM) fuel cell.

13. A portable electronic device, comprising:
a set of components powered by a power source; and
the power source, comprising:
a set of fuel cells arranged in a fuel cell stack; and
a power bus configured to connect the fuel cells in a parallel configuration.

14. The portable electronic device of claim 13, wherein the power source further comprises:
a voltage-multiplying circuit configured to increase a voltage of the fuel cell stack.

15. The portable electronic device of claim 14, wherein the voltage-multiplying circuit is connected to the power bus.

16. The portable electronic device of claim 14, wherein the voltage-multiplying circuit increases the voltage of the fuel cell stack to at least an operating voltage of one or more of the components.

17. The portable electronic device of claim 13, wherein the fuel cells are arranged in a monopolar configuration that enables sharing of an electrode between two adjacent fuel cells in the fuel cell stack.

18. The portable electronic device of claim 13, wherein each of the fuel cells corresponds to a proton exchange membrane (PEM) fuel cell.

19. A power source, comprising:
a first fuel cell stack comprising a first set of fuel cells connected in a parallel configuration and arranged in a monopolar configuration that enables sharing of an electrode between two adjacent fuel cells in the first fuel cell stack; and
a second fuel cell stack comprising a second set of fuel cells connected in a parallel configuration,
wherein the first fuel cell stack and the second fuel cell stack are connected in a series configuration.

20. The power source of claim 19, wherein each of the fuel cells corresponds to a proton exchange membrane (PEM) fuel cell.
